(19) United States
(12) Patent Application Publication
(10) Pub. No.: US 2003/0075489 A1
(43) Pub. Date: Apr. 24, 2003

(54) Liquid and solid particle separating device

(76) Inventor: Gunrunathan Lakshman, Saskatoon (CA)

Correspondence Address: ADE & COMPANY, 1700-360 MAIN STREET, WINNIPEG, MB, R3C3Z3, CA

(21) Appl. No.: 10/238,899

(22) Filed: Sep. 10, 2002

Related U.S. Application Data
(60) Provisional application No. 60/317,989, filed on Sep. 10, 2001.

(51) Int. Cl. B01D 17/00

(52) U.S. Cl. 210/143; 210/519; 210/521; 210/532.1; 210/539; 210/540

(57) ABSTRACT

A separating device is provided for separating liquid from a slurry of liquid and solid particles. The device has a settling chamber including a filter screen spanning a liquid outlet opening at the open top end of the settling chamber. A slurry inlet, in communication with the settling chamber below the filter screen, introduces a slurry of liquid and solid particles into the settling chamber. Liquid is urged to escape from the settling chamber upwardly through the filter screen. The filter screen, being located at the top of the settling chamber, provides a more natural separation of the liquid from the solid particles by permitting the liquid to rise upwardly through the screen while the solid particles settle out in the settling chamber to be compacted at the bottom of the chamber for removal of the compacted solids from the bottom of the chamber.

### FIELD OF THE INVENTION

The present invention relates to a device for separating liquid from a slurry of liquid and solid particles.

### BACKGROUND

Slurries of liquid and solid particles are commonly found in many industries where it is desirable to separate the liquid and solid components of the slurry. These industries include waste water processing, industrial sludge, food processing and pulp mills.

Known systems for de-watering generally include a filter screen into which the slurry or sludge is forced so that the liquid is able to pass through the filter screen leaving the solid particles trapped by the screen. The solid particles however must be removed when the screen becomes plugged in order to maintain efficiency of the filter screen. Screens in this arrangement are commonly plugged because the liquid and solid particles are forced in the same direction into the screen during the filtering process.

U.S. Pat. No. 5,009,795 to Eichler and U.S. Pat. No. 5,833,851 to Adams provide examples of a screw press for de-watering solids suspended in liquid. In each of these devices an auger is provided for pressing a slurry of solid particles suspended in liquid against the surrounding walls of the auger which includes a screen therein for permitting the liquid to escape. The solid particles however are continuously pressed against the filter screen thus reducing the efficiency of the screen by causing the screen to be plugged up with solid particles.

U.S. Pat. No. 6,135,293 to Herbst provides a water and sludge filter press in which a filter bag filled with water and sludge is pressed between a pair of opposing screens arranged so that the water is permitted to escape through the filter bag which traps the sludge and solid particles therein. The press requires the filter bags to be emptied when the sludge accumulates therein in use.

U.S. Pat. No. 5,997,750 to Rozelle provides a drinking water purification system for producing purified drinking water from surface or ground water sources. Positively charged filtration media are used to attract typically negatively charged suspended solids present in the water source. A filter column is used having screens therein which require periodic cleaning due to the accumulation of solid particles thereon because the liquid and solid particles suspended therein are forced to flow in the same direction into the screen.

### SUMMARY

According to one aspect of the present invention there is provided a separating device for separating liquid from a slurry of liquid and solid particles, the device comprising:

a settling chamber arranged for containing liquid therein having a liquid outlet opening at a top end thereof;

filter means spanning the liquid outlet opening at the top end of the chamber; and

a slurry inlet in communication with the settling chamber below the filter means arranged to introduce the slurry of liquid and solid particles into the settling chamber;

whereby introduction of the slurry of liquid and solid particles into the settling chamber urges liquid to escape from the settling chamber upwardly through the filter means spanning the liquid outlet opening.

The arrangement of a separating device wherein the filter screen is located at the top of a settling chamber located therebelow provides a more natural separation of the liquid from the solid particles by permitting the liquid to rise upwardly through the screen while the solid particles settle out in the settling chamber to be compacted at the bottom of the chamber.

In further variations, compaction of the solid particles is improved by providing a filter screen which is movable upwardly and downwardly to press the solid particles down into the settling chamber when the screen is lowered while permitting fresh liquid to flush the bottom side of the screen when the screen is raised. The solid particles may be removed from the settling chamber by a solid particle outlet located at the bottom of the chamber. Tapering the settling chamber downwardly and inwardly towards the solid particle outlet and providing an auger to urge the solid particles out through the solid particle outlet assists in compaction of the solid particles within the settling chamber.

### BRIEF DESCRIPTION OF THE DRAWING

In the accompanying drawing, which illustrates an exemplary embodiment of the present invention:

FIG. 1 is a schematic view of the separating device for separating liquid from a slurry of liquid and solid particles.

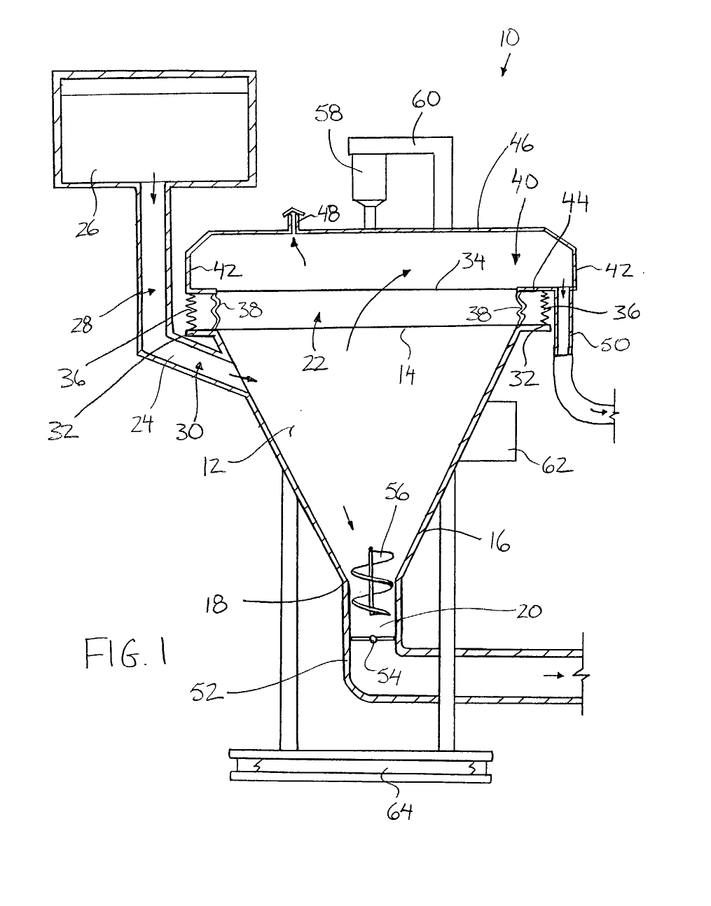

### DETAILED DESCRIPTION

Referring to the accompanying drawing, there is illustrated a separating device generally indicated by reference numeral 10. The separating device 10 is intended for separating liquid from a slurry of liquid and solid particles which has particular application in the treatment of waste water as well as many other similar process in which it is desirable to de-water slurries or sludge.

The device generally includes a settling chamber 12 which is generally conical in shape having a large open top end 14 and walls 16 which taper downwardly and inwardly to an apex at a bottom end 18 of the chamber. A solid particle outlet 20 is located at the bottom end 18 of the chamber while the open top end 14 defines a liquid outlet 22.

A slurry is introduced into the settling chamber 12 by a slurry inlet 24 coupled to communicate through a wall of the settling chamber 12 spaced upwardly from the bottom end 18 of the chamber adjacent the open top end 14 thereof. Coupling the slurry inlet 24 to the chamber at a location spaced upwardly from the bottom end of the chamber reduces the possibility of liquid becoming trapped within the compacted solids at the bottom end of the chamber.

The slurry inlet 24 is coupled between the chamber 12 and a source of the slurry at a reservoir 26. The reservoir 26 is arranged to be substantially higher in elevation than the open top end of the settling chamber such that the resulting hydrostatic head between the reservoir 26 and the chamber 12 causes the slurry to flow through the slurry inlet into the chamber.

The slurry inlet 24 is in the form of an enclosed pipe which extends downwardly from the reservoir 26 at a first portion 28 and then extends at a downward incline through a second portion 30 which communicates with the chamber 12. An angle between the first and second portions of the slurry inlet pipe is an obtuse angle so as to reduce the possibility of obstruction at the bends in the pipe with the second portion 30 of the pipe entering the chamber 12 at a downward incline of approximately 45 degrees from horizontal to direct solid particles in the slurry away from the open top end of the chamber.

The liquid outlet 22 at the open top end of the chamber is arranged to be substantially greater in cross sectional area then the slurry inlet 24 so as to reduce upward velocity of the slurry entering the chamber to induce settling and minimize mixing of the liquid and solid particles.

The open top end 14 of the chamber 12 includes a support flange 32 extending laterally outwardly from a periphery of the chamber for supporting a filtering screen 34 at the liquid outlet 22. The filtering screen 34 is a conventional type screen which may be formed of stainless steel or Teflon for example.

A series of springs 36 are mounted about a periphery of the filter screen 34 for supporting the periphery of the screen on the support flange 32. The screen 34 is thus supported to span horizontally across the liquid outlet 22 while being movable relative to the settling chamber 12 on the springs 36 in a vertical direction transversely to the direction in which the screen spans. The springs 36 are supported between the screen 34 and the flange 32 so as to be oriented in a direction to urge the screen upwardly and away from the settling chamber.

A flexible baffle 38 is coupled between the periphery of the screen 34 and the walls 16 of the settling chamber for sealing therebetween such that the screen is sealed with respect to the chamber walls so that the liquid is forced to pass through the screen 34 in order to escape through the open top end of the chamber 12. The springs 36 are mounted externally of the baffle 38 so as to be shielded from the liquid and slurry within the chamber 12.

A collecting pan 40 spans laterally outwardly from the periphery of the screen 34 for supporting the periphery of the screen on the springs 36. The pan 40 includes side walls 42 which extend upwardly from a flat bottom 44 of the pan which is in horizontal alignment with the screen 34. The side walls 42 are enclosed at a top end by an enclosure 46 spanning the side walls spaced upwardly from the screen, defining an outlet chamber within the enclosure 46 of the collecting pan 40 adjacent an outer side of the screen 34. The enclosure includes a gas vent 48 which is coupled to a gas line and arranged to release gases collected within the enclosure 46 in a controlled manner. The gas vent 48 communicates with the outer side of the screen and is open and closed by a controller for venting gas therefrom as required.

The flat bottom 44 of the collecting pan 40 includes a liquid drain line 50 coupled thereto having an opening which is level with the screen 34 at an elevation which is well below the reservoir 26 of the slurry inlet such that hydrostatic head from the slurry within the reservoir urges the liquid through the screen 34 to be subsequently drained through the liquid drain line 50. The liquid drain line 50 being coupled with the collecting pan 40 is thus also arranged to communicate with the outer side of the filter screen 34.

The solid particle outlet 20 includes an outlet pipe coupled to communicate with the bottom end 18 of the settling chamber to extend downwardly and outwardly therefrom. A ball valve 54 is mounted within the outlet pipe 52 spaced below the bottom end 18 of the chamber 12 for selectively discharging compacted solid particles from the settling chamber when the ball valve 54 is opened.

A screw press is provided in the form of an auger 56 mounted within the outlet pipe 52 above the ball valve 54 for communication with the compacted solid particles in the bottom end of the chamber 12. The auger 56 is mounted for rotation about a longitudinal axis of the outlet pipe 52 containing the auger therein for urging the compacted particles through the outlet pipe 52 when the ball valve 54 is opened and the auger is rotated.

A compaction mechanism is provided in the form of an actuator 58 coupled to the collecting pan 40 above the settling chamber 12. The actuator 58 is mounted between the enclosure 46 on a top side of the collecting pan and a support arm 60 which is fixed in relation to the settling chamber 12. Actuation of the actuator 58 causes the actuator above the enclosure 46 to be extended for urging the collecting pan and the screen 34 connected thereto to move together downwardly against the slurry of liquid and solid particles within the settling chamber.

The actuator 58 is thus oriented to act against the springs 36 to compact the solid particles within the chamber 12. The springs 36 urge the screen back up to a starting position when the actuator 58 is released. A controller is provided to actuate displacement of the screen and collecting pan 40 coupled thereto at a prescribed frequency of oscillation which can be adjusted and pre-set as required.

Displacement of the screen involves compression of the flexible baffle 38 in the order of approximately eighty percent of the height of the baffle which corresponds to possibly three to four inches as an example. In use, the actuator 58 would be actuated to displace the screen 34 downward into a compacted position of the solid particles in the chamber in the order of once every thirty seconds.

A vibrator 62 may be coupled to the walls of the settling chamber 32 in a manner so as to be arranged to transmit vibrations through the chamber walls 16 to the slurry therein for assisting in the separation of liquid and solid particles while also assisting in compaction of the solid particles at the bottom end of the settling chamber.

A mass sensor 64 may be provided which is coupled to the settling chamber 12 in a manner so as to measure a mass of the slurry within the settling chamber or a specific gravity thereof. The mass sensor 64 is used to determine when a specific gravity of the settling chamber contents are greater than a prescribed solid particle threshold which is pre-set for indicating when sufficient solid particles have been collected that the ball valve 54 of the solid particle outlet can be opened to remove at least some of the compacted solid particles. For example if the solid particles in question have a specific gravity of four relative to the liquid within which it is suspended, the prescribed solid particle threshold would be a magnitude which would be close to but below the expected specific gravity of the solid particles. In this example, a suitable threshold may be a specific gravity of three.

In alternate arrangements the chamber 12 is determined to be requiring emptying of compacted solid particles based upon the expiry of a timer if the slurry conditions are constant or predictable. For greater accuracy, measurement of the amount of solid particles compacted within the settling chamber can be determined using an ultrasonic monitor for example or a pressure sensor on the screen 34 for sensing when the pressure of compacted solids exerted on the screen when the screen is lowered reaches a prescribed pressure threshold.

In use, the slurry of liquid and solid particles is introduced into the settling chamber through the slurry inlet 24 at a sufficiently slow rate so as not to induce turbulence or mixing within the settling chamber but rather to induce settling of solid particles. This is encouraged by having a slurry inlet 24 with a small cross-sectional area relative to the cross-sectional area of the chamber 12 and more particularly the liquid outlet 22. Positioning the slurry inlet 24 as close to the open top end 14 of the settling chamber 12 as possible prevents liquid from being trapped within the layers of compacted solid particles at the bottom end of the settling chamber while ensuring a continuous supply of liquid near the screen 34 for flushing solid particles from the screen in operation.

The inflow through the slurry inlet 24 may be provided by a pump in an alternate arrangement, however the inflow must be at a sufficiently slow rate so as not to induce to much turbulence or mixing as noted above, and therefore an induced flow due to the hydrostatic head of the reservoir 26 is preferred.

During a separating operation, the screen 34 is oscillated in a vertical direction for compacting the solid particles downwardly to the bottom end of the settling chamber. Oscillations of the screen 34 follow a prescribed period which can be constant or varied depending upon conditions sensed within the settling chamber 12. Oscillation of the screen 34 is much slower than the vibrations induced within the chamber 12 by the vibrator 62.

As determined by appropriate sensors noted above, the solid particles compacted within the settling chamber are periodically dumped when a controller determines that the solid particle threshold has been exceeded. The controller then opens the ball valve 54 upon which the auger 56 is responsive so that the auger begins to rotate when the valve is opened to urge the compacted solid particles out of the settling chamber through the outlet pipe 52. A suitable valve or control may be provided on the slurry inlet 24 to stop inflow when the ball valve 54 is opened. Once a predetermined amount of solid particles are removed from the settling chamber 12 the ball valve 54 is again closed and the inflow through the slurry inlet 24 is again arranged to introduce slurry into the settling chamber. As the slurry is introduced, pressure from the slurry entering urges the lighter liquid at the open top end of the settling chamber 12 to pass upwardly through the screen 34 and overflow into the liquid drain line 50. The gas vent 48 is controlled by appropriate sensors for determining when sufficient gas has built up within the enclosure 46 that the release of gas is required.

This device ensures that the liquid and solid particles are displaced in different directions with the heavier solids being directed towards the bottom end of the settling chamber while the lighter liquid is permitted to overflow upwardly through the screen. The location of the screen at the top end of the settling chamber ensures that the lighter fluids constantly gravitate to the screen for flushing the screen and reducing clogging of the inside of the screening surface by solid particles within the settling chamber. After the liquid has been separated from the settling chamber 12 for overflowing through the liquid drain line 50, the liquid may be passed through subsequent treating operations as required depending upon the process within which the separating device is a component.

While one embodiment of the present invention has been described in the foregoing, it is to be understood that other embodiments are possible within the scope of the invention. The invention is to be considered limited solely by the scope of the appended claims.

1. A separating device for separating liquid from a slurry of liquid and solid particles, the device comprising:
a settling chamber arranged for containing liquid therein having a liquid outlet opening at a top end thereof;
filter means spanning the liquid outlet opening at the top end of the chamber; and
a slurry inlet in communication with the settling chamber below the filter means arranged to introduce the slurry of liquid and solid particles into the settling chamber;
whereby introduction of the slurry of liquid and solid particles into the settling chamber urges liquid to escape from the settling chamber upwardly through the filter means spanning the liquid outlet opening.

2. The separating device according to claim 1 wherein the settling chamber includes walls which are tapered inwardly and downwardly towards a bottom end of the settling chamber.

3. The separating device according to claim 1 wherein the slurry inlet comprises a passage extending at a downward incline at a point of communication with the settling chamber.

4. The separating device according to claim 1 wherein a cross sectional area of the liquid outlet opening is substantially greater than a cross sectional area of the slurry inlet.

5. The separating device according to claim 1 wherein the slurry inlet includes a source for containing the slurry of liquid and solid particles therein, the source being higher in elevation than the liquid outlet opening.

6. The separating device according to claim 1 wherein there is provided a solid particle outlet in communication with the settling chamber below the slurry inlet and valve means for selectively closing the solid particle outlet.

7. The separating device according to claim 6 wherein there is provided a feed mechanism coupled to the solid particle outlet arranged to urge compacted solid particles out of the settling chamber through the solid particle outlet.

8. The separating device according to claim 7 wherein the feed mechanism is operable in response to the valve means being opened.

9. The separating device according to claim 6 wherein the valve means are opened in response to a specific gravity of a slurry of liquid and solid particles in the settling chamber being greater than a prescribed solid particle threshold.

10. The separating device according to claim 1 wherein the filter means comprises a screen spanning generally horizontally across the liquid outlet opening.

11. The separating device according to claim 10 wherein the screen is movable relative to the settling chamber in a direction extending transversely to a direction which the screen spans.

12. The separating device according to claim 11 wherein there is provided a flexible baffle connected between a periphery of the screen and the settling chamber for sealing the screen with respect to the settling chamber while permitting relative movement therebetween.

13. The separating device according to claim 11 wherein there is provided an actuator arranged to control movement of the screen relative to the settling chamber.

14. The separating device according to claim 11 wherein the actuator is arranged to move the screen relative to the settling chamber at a prescribed frequency of oscillation.

15. The separating device according to claim 11 wherein there is provided biasing means supporting the screen on the settling chamber oriented in a direction to urge the screen upwardly away from the settling chamber.

16. The separating device according to claim 15 wherein there is provided an actuator arranged to control movement of the screen relative to the settling chamber, the actuator being oriented in a direction to act against the biasing means.

17. The separating device according to claim 11 wherein there is provided an enclosure arranged to enclose an outer side of the screen opposite the settling chamber.

18. The separating device according to claim 17 wherein there is provided a liquid drain line coupled to the enclosure in communication with the outer side of the screen.

19. The separating device according to claim 17 wherein there is provided a gas vent line coupled to the enclosure in communication with the outer side of the screen.

20. The separating device according to claim 1 wherein there is provided a vibrating mechanism arranged to transmit vibrations to the settling chamber for assisting separation of solid particles from liquid in the settling chamber.
